(19) United States
(12) Patent Application Publication
(10) Pub. No.: US 2017/0114659 A1
(43) Pub. Date: Apr. 27, 2017

(54) TURBINE ENGINE COMPRESSOR WITH VARIABLE-PITCH BLADES

(71) Applicant: SAFRAN HELICOPTER ENGINES, Bordes (FR)

(72) Inventors: Frédéric Imbourg, Pau (FR); Philippe Nectoute, Bosdarros (FR); Mathieu Herran, Garderes (FR)

(73) Assignee: SAFRAN HELICOPTER ENGINES, Bordes (FR)

(21) Appl. No.: 15/302,133

(22) PCT Filed: Apr. 1, 2015
(86) PCT No.: PCT/FR2015/050848

§ 371 Date: Oct. 5, 2016

(30) Foreign Application Priority Data
Apr. 8, 2014 (FR) 1453128

(51) Int. Cl. F01D 17/16; F04D 29/56; F01D 11/02; F04D 29/10; F01D 9/04; F01D 11/00

(52) U.S. Cl. CPC F01D 17/162; F01D 9/041; F01D 11/001; F01D 11/02; F01D 11/005; F04D 29/102; F04D 29/563; F05D 2240/55

(57) ABSTRACT

A turbine engine compressor has at least one annular row of variable-pitch stator vanes that are substantially radial and have pivots at their radial ends. The radially outer pivots of the vanes are received in first openings in a stator casing and the radially inner pivots are received in second openings in a floating ring that surrounds a rotor of the compressor. An annular stator part is inserted between the floating ring and the rotor of the compressor, and first sealing means are mounted between the stator part and the rotor of the compressor. Second sealing means are mounted between the floating ring and the stator part.

### TECHNICAL FIELD

The present invention relates to a turbine engine compressor, in particular for an aircraft, and more specifically to a turbine engine compressor comprising at least one annular row of variable-pitch stator vanes.

### PRIOR ART

In a turbine engine compressor, an annular row or a grating of variable-pitch stator vanes is mounted upstream or downstream of a rotor wheel of the compressor in order to form a compression stage. The variable-pitch vanes are supported by the stator of the compressor and are adjustable in terms of position about radial axes in order to optimise the flow of the gases in the turbine engine. These vanes are often referred to as IGV vanes, with IGV standing for inlet guide vane.

The variable-pitch vanes of a turbine engine compressor are substantially radial and comprise substantially cylindrical pivots at the radial ends thereof. The radially outer pivots of the vanes are received in first openings in a stator casing of the compressor, and the radially inner pivots thereof are received in second openings in a stationary or floating ring, which surrounds the rotor of the compressor. A ring is stationary when it is rigidly connected to the stator, and is floating when it is separate from the stator and can therefore move relative to the stator. The pivots of the vanes are guided in rotation in the receiving openings thereof by means of bushings surrounding the pivots.

Each vane can be moved in rotation about the axis defined by its pivots. This movement is generally ensured by an actuator that is mounted on the stator casing and is connected to a control ring that is itself connected to the radially outer pivots of the vanes by means of connecting rods. The rotation of the control ring is transmitted by the connecting rods to the outer pivots of the vanes and causes said vanes to turn about their axes.

In operation, during the rotation of the variable-pitch vanes about their axes, the pivots of the vanes rub against the bushings. Using a floating ring rather than a stationary ring makes it possible to reduce the interface forces on the inner pivots of the vanes and to thus limit the wear on these pivots by rubbing against the bushings thereof.

The floating ring is inserted radially between the variable-pitch vanes and the rotor of the compressor, and its outer periphery defines the internal diameter of the air flow duct in the compressor. The external diameter of the flow duct is defined by the above-mentioned stator casing. The air flow rate in the compressor can be increased by increasing its passage cross section in the region of the row of variable-pitch vanes, which may be achieved either by increasing the external diameter of the flow duct or by reducing its internal diameter, or by doing both. Increasing the external diameter of the flow duct is not a satisfactory solution since this results in an increase in the external diameter of the stator casing and therefore an increase in its overall size, and also in reductions in performance linked to the increase in the Mach number at the head (and a difficulty in mechanically dimensioning the downstream movable wheel linked to the increase in the peripheral speed). The other solution therefore involves reducing the internal diameter of the flow duct. However, this solution is difficult to implement in the above-mentioned technology using a floating ring.

Indeed, in order to prevent air from recirculating from downstream to upstream between the floating ring and the rotor, air-sealing means are inserted between the floating ring and the rotor. These sealing means generally comprise a labyrinth seal comprising annular wipers that are supported by the rotor and cooperate with an annular layer of abradable material supported by the floating ring. These sealing means are relatively bulky, in particular in the radial direction, and this prevents the internal diameter of the compressor flow duct from being reduced.

Moreover, additional sealing means are generally provided in this region close to a bearing chamber containing oil. These additional sealing means comprise two other labyrinth seals, which are spaced apart axially and define an annular cavity therebetween that is intended to be supplied with compressed air. The rotor of the compressor is tubular and comprises, on its wall, a radial opening of which the radially outer end leads into the cavity for supplying said rotor with compressed air, this air being intended to flow in the upstream direction and in the downstream direction and to pass through the two labyrinth seals defining the cavity, in order to prevent oil from passing through these seals. The additional sealing means are therefore sealing means for preventing oil leaks. The oil comes from a lubricating chamber upstream of the sealing means, which chamber receives a guide bearing of the rotor of the compressor.

In order to prevent oil leaks from the chamber, the sealing means are not designed to ensure sealing between the floating ring and the rotor such that they prevent the recirculation of air from downstream to upstream. It is therefore not conceivable to simply remove the air-sealing means in order to be able to provide a reduction in the internal diameter of the compressor flow duct.

The present invention proposes a simple, effective and economical solution to the problem from the prior art.

### DISCLOSURE OF THE INVENTION

The invention proposes a turbine engine compressor, comprising at least one annular row of variable-pitch stator vanes, these vanes being substantially radial and comprising pivots at their radial ends, the radially outer pivots of the vanes being received in first openings in a stator casing and the radially inner pivots being received in second openings in a floating ring that surrounds a rotor of the compressor, characterised in that an annular stator part is inserted between the floating ring and the rotor of the compressor, and in that first sealing means are mounted between the stator part and the rotor of the compressor, and second sealing means are mounted between the floating ring and the stator part.

The floating ring is therefore no longer mounted directly around a compressor rotor, but is instead mounted directly around a stator part which itself surrounds the compressor rotor. According to the invention, the (first) sealing means, which are preferably systems having an air discharge calibrated to prevent oil leaks, are mounted between the stator part and the rotor of the compressor, and the (second) sealing means, which are preferably mechanical sealing means, are mounted between the floating ring and the stator part. These last-mentioned sealing means allow movements of the floating ring relative to the stator part during operation, which movements are essentially movements in the axial direction and in the tangential direction (the movements in the radial direction having relatively low amplitudes). Although the floating ring can move, it is part of the stator of the compressor. The second means are therefore intended to ensure sealing between two stator parts and may therefore be much less bulky than those used in the prior art to ensure sealing between a stator portion and a rotor portion.

The first sealing means may be of the labyrinth seal type or of the carbon ring type, and may define an annular cavity that is designed to be supplied with pressurised air.

According to an embodiment of the invention, the second sealing means comprise at least one annular seal or at least one annular segment, which is received in a groove in the stator part and cooperates in a sealing manner with the floating ring, or vice versa.

The second sealing means comprise, for example, two adjacent annular segments that are received in the same annular groove.

Preferably, the annular segment(s) cooperate with a portion of the floating ring that is covered with an anti-friction coating.

The compressor according to the invention may be an axial compressor, a centrifugal compressor or a mixed compressor. Therefore, a centrifugal-compressor wheel or an annular row of rotor blades of the axial compressor may be mounted downstream of the row of variable-pitch vanes.

The present invention also relates to a turbine engine, characterised in that it comprises a compressor as described above.

### DESCRIPTION OF THE DRAWINGS

The invention will be better understood, and other details, features and advantages of the invention will become apparent upon reading the following description, given by way of non-limiting example and with reference to the accompanying drawings, in which:

FIG. 1 is a schematic half view in axial section of a turbine engine compressor according to the prior art,

FIG. 2 is a schematic half view in axial section of a turbine engine compressor according to the invention, and

FIG. 3 is a larger-scale view of the detail I₃ from FIG. 2.

### DETAILED DESCRIPTION

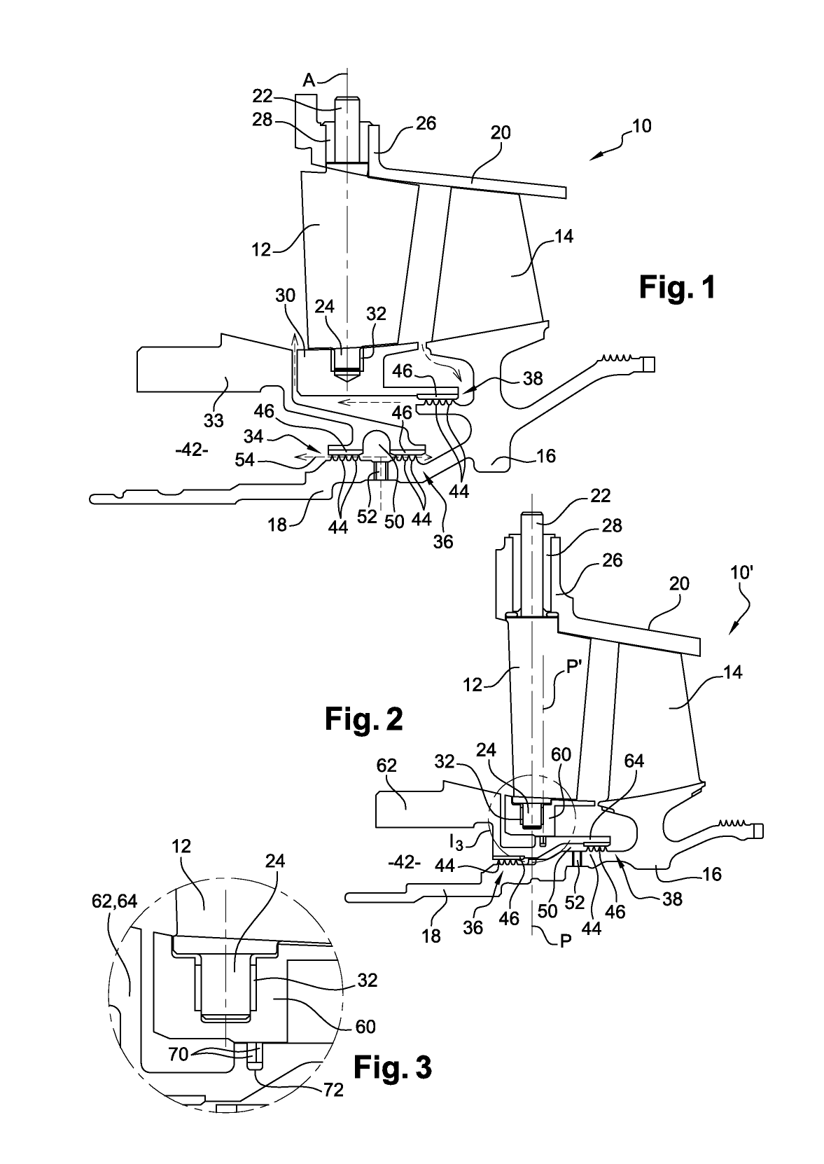

Reference is made first of all to FIG. 1, which shows a turbine engine compressor 10 according to the prior art, for an aircraft. In this figure, this compressor 10 is shown in part and comprises an annular upstream row of variable-pitch stator vanes 12 and an annular downstream row of rotor blades 14. Upstream and downstream refer to the flow direction of the air in the compressor, which is from left to right in the figure.

The rows of vanes/blades 12, 14 extend around the longitudinal axis of the turbine engine. The rotor blades 14 are substantially radial and are supported by a disc 16, the assembly comprising the disc and the blades 14 forming a rotor wheel of the compressor. The wheel is rigidly connected to a rotor shaft 18 and is surrounded by a stator casing 20, which also surrounds the row of stator vanes 12.

The stator vanes 12 are substantially radial and comprise a radial cylindrical pivot 22, 24 at each of their radially inner and outer ends. The pivots 22, 24 of each vane 12 define the axis A of rotation and of angular pitch of the vane.

The outer cylindrical pivot 22 or control pivot of each vane 12 is inserted into the receiving portion of a cylindrical pipe 26 of the housing 20 and is centred and guided in rotation in this pipe by a cylindrical bushing 28 that is mounted around the outer pivot 22.

The radially outer end of the outer pivot 22 is intended to be secured to an end of a connecting rod, the other end of which is connected to a control ring (not shown) that extends around the axis of the turbine engine, on the outside of the casing 20. An angular movement of the control ring about the axis of the turbine engine is translated into rotation of the connecting rods about the axes A of the vanes 12 and into the variable-pitch vanes 12 being driven in rotation about these axes.

The inner cylindrical pivot 24 or the guide pivot is inserted into a cylindrical receiving portion of a floating ring 30 and is centred and guided in rotation in this receiving portion by a cylindrical bushing 32.

A sealing means 38 is mounted between the floating ring 30 and the disc 16, and two other sealing means 34 and 36 are mounted between a stator part 33 and the shaft 18. In the prior art shown in FIG. 1, the sealing means 38 comprise a labyrinth seal 38 that prevents air coming from the flow duct of the compressor from recirculating from downstream to upstream between the floating ring 30 and the disc 16. This labyrinth seal 38 comprises annular wipers 44 that are supported by the disc 16 and cooperate with an annular layer 46 of abradable material supported by the floating ring 30.

The other sealing means are labyrinth seals 34, 36, and prevent oil from passing between the floating ring 30 and the stator part 33, in particular from upstream, where there is a chamber 42 for lubricating a guide bearing of the shaft 18, in which chamber an oil mist prevails. These labyrinth seals 34, 36 each comprise annular wipers 44 that are supported by the shaft 18 and cooperate with an annular layer 46 of abradable material supported by the stator part 33.

The seals 34, 36 are axially spaced apart and define therebetween an annular cavity 50 intended to be supplied with compressed air and to therefore be pressurised. The shaft 18 is tubular and comprises a radial opening 52 of which the radially outer end leads into the cavity 50 for supplying said shaft with compressed air, this air being intended to flow in the upstream direction and in the downstream direction and to pass through the seals 34, 36 (arrows 54), in order to prevent oil from passing through said seals, in particular oil from the upstream chamber 42.

The invention makes it possible to reduce the overall size of the floating ring, in particular the overall radial size thereof, and to provide a reduction in its external diameter with a view to increasing the passage cross section of the compressor and therefore the air flow rate therein. This is made possible by inserting an annular stator part between the floating ring and the stator.

FIGS. 2 and 3 show an embodiment of the invention. In these figures, the elements that have already been described above are provided with the same reference numerals and will not be described in the following. The above description, which relates to the prior art, therefore applies to these elements.

In the example shown, the floating ring 60 surrounds a downstream portion 64 of an annular stator part 62, which itself extends around the shaft 18. The floating ring 60, the stator part 62 and the shaft 18 are coaxial. The floating ring 60 and the upstream portion of the stator part 62 form a portion of the flow duct of the compressor 10′.

The inner cylindrical pivot 24 of each vane 12 is inserted into a cylindrical receiving portion of the floating ring 60 and is centred and guided in rotation in this receiving portion by a cylindrical bushing 32 (optional).

The (second) sealing means, which comprise two labyrinth seals 36, 38, are mounted between the stator part 62 and the shaft 18, and in particular between the downstream portion 64 of this part 62 and the shaft 18. Each of these seals 36, 38 comprises wipers 44 and an abradable layer 46, as described above.

The (first) sealing means 70, which prevent air coming from the flow duct of the compressor 10′ from recirculating from downstream to upstream, are in this case mounted between the floating ring 60 and the stator part 62, and more specifically between the inner periphery of the floating ring 60 and the downstream portion 64 of the part 62.

In the example shown, these air-sealing means comprise annular segments 70 that are mounted in an annular groove 72 in the downstream portion 64 of the stator part 62, this annular groove 72 leading radially towards the outside.

There are two sealing segments 70 in this case. Each segment is split and has, in its inoperative position without stress, an external diameter that is greater than that of the groove 72. The opening in the segments makes it easier for said segments to be mounted in the groove, it being possible to increase the diameter of the segments beyond the external diameter of the downstream portion 64 of the part 62 by spreading apart the free circumferential ends of said segments. In the mounting position, the segments 70 are subject to radial stress and abut the inner periphery of the floating ring 60 by their outer periphery. In this case, the two segments 70 are arranged one beside the other, it being possible for the openings therein to be offset in the tangential direction to prevent air from passing therethrough.

The segments 70 can move in the groove 72, in particular in the circumferential direction. Said segments allow movements of the floating ring 60 relative to the stator part 62 during operation. The inner surface of the floating ring 60, which is intended to cooperate with the segments, may be covered with an anti-friction coating, such as NiCrAlY (alloy based on nickel, chrome, aluminium and yttrium).

The floating ring 60 and the stator part 62 are made of aluminium, for example. They may be divided into sectors, the sectors being secured to one another by bolts, for example.

In a variant, the segments 70 may be received in an annular groove in the floating ring 60 and may cooperate in a sealing manner with the stator part 62.

In another variant, the sealing means between the bodies 60, 62 comprise at least one annular seal, such as an elastically deformable O-ring, for example made of elastomer.

In yet another variant, the impeller 14 positioned downstream of the variable-pitch vanes 12 may be replaced with a centrifugal compressor wheel.

1. A turbine engine compressor, comprising at least one annular row of variable-pitch stator vanes, the vanes being substantially radial and comprising pivots at radial ends of the vanes, the radially outer pivots of the vanes being received in first openings in a stator casing and the radially inner pivots being received in second openings in a floating ring that surrounds a rotor of the compressor, wherein an annular stator part is inserted between the floating ring and the rotor of the compressor, and in that first sealing means are mounted between the stator part and the rotor of the compressor, and second sealing means are mounted between the floating ring and the stator part.

2. The compressor according to claim 1, wherein the first sealing means are of the labyrinth seal type, and define an annular cavity that is configured to be supplied with pressurised air.

3. The compressor according to claim 1, wherein the second sealing means comprise at least one annular seal or at least one annular segment, which is received in an annular groove in the stator part and cooperates in a sealing manner with the floating ring, or vice versa.

4. The compressor according to claim 3, wherein the second sealing means comprise two adjacent annular segments that are received in the same annular groove.

5. The compressor according claim 3, wherein the annular segment(s) cooperate with a portion of the floating ring that is covered with an anti-friction coating.

6. The compressor according to claim 1, wherein a centrifugal-compressor wheel or an annular row of rotor blades of the axial compressor is mounted downstream of the row of variable-pitch vanes.

7. A turbine engine, comprising a compressor according to claim 1.
